(19) United States
(12) Patent Application Publication
(10) Pub. No.: US 2014/0201339 A1
(43) Pub. Date: Jul. 17, 2014

(54) METHOD OF CONDITIONING COMMUNICATION NETWORK DATA RELATING TO A DISTRIBUTION OF NETWORK ENTITIES ACROSS A SPACE

(71) Applicant: TELEFONAKTIEBOLAGET L M ERICSSON, Stockholm (SE)

(72) Inventors: Perikles Rammos, Athlone (IE); Yangcheng Huang, Athlone (IE); Jason Roche, Wexford (IE)

(73) Assignee: TELEFONAKTIEBOLAGET L M ERICSSON (PUBL), Stockholm (SE)

(21) Appl. No.: 14/122,456

(22) PCT Filed: May 27, 2011
(86) PCT No.: PCT/EP2011/058739

§ 371 Date: Mar. 3, 2014

(51) Int. Cl. H04L 12/24

(52) U.S. Cl. CPC H04L 41/0823
USPC 709/220

(57) ABSTRACT

A method and apparatus for conditioning communication network data relating to a distribution of network entities across a space, for subsequent processing of the network data, is disclosed. The method comprises dividing the space into a grid comprising a plurality of discrete cells, so that each cell comprises a unique location within the space. The network data relating to each entity is subsequently processed using a processor to assign the network entity to a cell in dependence of the location of the entity within the space, relative to the cells. Following the discretisation of network entities to a particular cell, the number of entities within the cells is determined. The number of entities associated with the cells is then separately compared with the number of entities within each cell of a respective cell distribution using the processor, to determine the cell maxima of each distribution which comprises the most entities. The location of the cell maxima within the grid is subsequently output to a processor for subsequent processing of the network data, for monitoring of the communication network.

### TECHNICAL FIELD

The invention relates to a method of conditioning communication network data relating to a distribution of network entities across a space, for subsequent processing of the network data.

### BACKGROUND

The monitoring of modern telecommunications networks produces vast amounts of data that need to be efficiently processed in order to extract useful information. The manipulation of the raw data, presents severe difficulties, due to the sheer volume and diversity of the datasets associated with the network entities. For example, the processing of the raw data by an automated algorithm requires significant processing capabilities, such as time, computing power and memory. Similarly, providing a visual representation of the data to an operator can overwhelm the user with the sheer amount of information. Accordingly, it is evident that the processing limitations either by a processor or an operator, presents opportunities for errors to develop and thus corrupt or otherwise false information to be presented. The above are computational and usability issues that are unfortunately synergistic, since one intensifies the other; for example, the slow response of the computer will further hinder the difficult conveying of information to the user.

Solutions to these problems have been proposed which reduce the number of elements to process, without greatly reducing the conveyed information and usability. The reduction of the number of elements of the dataset, would allow for improved interactivity with the dataset, both for the human user (since less objects would be shown on-screen, and so the user would find much easier to discern information and interact with the dataset), as well as for an automated algorithm, since the computational resources would be significantly lower when processing a reduced number of elements. This reduction can be done either by filtering the data or by grouping the data into clusters—a process known as clustering.

When filtering is used, the elements of the dataset are assigned with a “quality” value, such that only the elements that surpass a certain quality threshold will proceed to the main processing stage. The elements below the threshold will be ignored. However, it is evident that this disregard of selected datasets results in substantial loss of information, which is ultimately propagated to the main processing stage.

When clustering is used, the elements of the dataset are grouped together by similarity. These groups or clusters of elements are subsequently processed, or visualized, instead of each element individually. This approach has the additional advantage of conserving all the information of the dataset, while maintaining reach-ability with all the elements disposed therein.

There are a variety of cluster analysis algorithms currently available, such as the so-called DBSCAN, k-means, OPTICS and BIRCH, However, the most widely used algorithms include k-means and DBSCAN.

The k-means algorithm is known to perform very well for large datasets and has spawned a family of related algorithms. However, the major drawback associated with k-means is that it needs to know a priori the number and location of the clusters (though the latter can be self-adjusted by the algorithm). In contrast, DBSCAN can infer the number of clusters, as well as detect complex-shaped clusters. However, for large datasets, it performs relatively poorly, and the clustering results do not often conform with an intuitive understanding.

In view of the above, it is evident that existing clustering techniques present several disadvantages when applied to the monitoring of a very large telecommunication networks, since for example with DBSCAN, the response time, namely the time to generate the clusters is found to significantly affect the interactivity performance of the monitoring system. In addition, DBSCAN does not perform well for datasets with varying density, which is an unavoidable feature in describing telecommunications networks.

In contrast, the k-means algorithm is known to perform well for large data sets, however, the algorithm, as with other known clustering algorithms, requires a priori knowledge of the number and the approximate location of the clusters before the processing of the data can take place. Accordingly, it is an object of the present invention is to provide a method of conditioning network data to provide the required input parameters for a subsequent cluster analysis.

### SUMMARY

In accordance with the present invention as seen from a first aspect, there is provided a method of conditioning communication network data relating to a distribution of network entities across a space, for subsequent processing of the network data. The method comprises dividing the space into a grid comprising a plurality of discrete cells, so that each cell comprises a unique location within the space. The network data relating to each entity is subsequently processed using a processor to assign the network entity to a cell in dependence of the location of the entity within the space, relative to the cells. Following the discretisation of network entities to a particular cell, the number of entities within the cells is determined. The number of entities associated with the cells is then separately compared with the number of entities within each cell of a respective cell distribution using the processor, to determine the cell maxima of each distribution which comprises the most entities. The location and number of the cell maxima within the grid is subsequently output to a processor for subsequent processing of the network data, for monitoring of the communication network.

Advantageously, the determination of the location of those cells comprising the most network entities in a given distribution provides for a reduced level of data processing within the subsequent processing stage, such as a k-means cluster algorithm, and therefore provides for a faster processing of the network data. The method examines the topography of the density of the entities across the space and utilises the most prominent areas, namely the cell maxima, as initial cluster locations. The method thus defines the number and approximate locations of the clusters, and therefore does not require any information regarding the number or location of the clusters. As a result, the method enables the subsequent processing of the network data, namely an iterative cluster analysis, for example to converge in a few iterative steps, thereby increasing the performance of the analysis. The invention allows for faster detection of failures or other unwanted behaviours of network infrastructure developing in the communication network. This, in turn, provides the advantage of minimising delay of reaction of a network management system these network problems.

The space may comprise a geographical distribution of network entities across a region or country for example, such that the method provides a suitable precursor to the further processing stage which may be arranged to provide an intuitive view of the network and the associated network entities. In this respect, the space and thus the cells provide for a two-dimensional distribution of network entities. However, it is envisaged that the space may comprise service space, physical space, time or a combination thereof, in which case, the cells of the method of the present invention may comprise further dimensions.

In an embodiment of the invention, the cell distribution comprises a neighbourhood of cells which surround a test cell and the number of entities within the test cell is compared with the number of entities within each cell of the neighbourhood to determine whether the test cell comprises the most entities. This comparison is performed across all cells of the grid to locate those cells comprising the most entities, namely the maxima, in their neighbourhood.

For a two-dimensional geographical space, the neighbourhood comprises a ring of cells around the test cell, however, it is to be appreciated that in the case of three or more dimensional space, the neighbourhood may be considered as a shell of cells which surround the test cell. The size of the neighbourhood, namely the extent to which the neighbourhood extends from the test cell is thus an important parameter in determining the location and thus number of maxima generated. In addition, the number of cells used to discretise the space and thus which form the grid is selectable to provide for a selectable resolution of network entities and so it is evident that the resolution and neighbourhood parameters directly influence the amount of data which is subsequently provided as input to the further processing stage.

In situations whereby the number of maxima produced during the comparative exceeds a predetermined threshold, which would otherwise restrict the subsequent processing of the maxima, the method may further include the additional step of processing the maxima to compare the number of entities associated with each maxima and to assign a quality value to each maxima, which may be representative of the number of entities associated with the respective maxima, or the total number of entities associated with the cells of the neighbourhood of the maxima, for example. Alternatively, or in addition thereto, the quality value may be representative of the location of the maxima relative to neighbouring maxima. The quality value is then used to further reduce the number of maxima and thus data which is subsequently promoted as input to the further processing stage.

The method of the present invention thus improves the performance of the resulting processing algorithm, thereby making it suitable for real-time processing and visualizations in network monitoring systems. This is in contrast to other traditional clustering algorithms whereby the performance makes it unsuitable for real-time processing. The increased performance resulting from the conditioning of the network data is also critical given the dynamic nature of incoming information from the network. For example, in the case of some network entities failing, it is critical that this information is processed and presented to the user very quickly, so that appropriate actions are taken. In the method of the present invention, dynamic data is handled very efficiently since the comparison of the number of entities within the cells does not have to be re-calculated from the beginning, but only updated to account for the entities that have changed state (e.g. from ‘functional’ to ‘failure’). In this manner, the cluster comprising the failed entities will be presented to the user almost immediately after the failures have occurred, thereby enabling the user to take the appropriate remedial action.

In an alternative embodiment, the cell distribution comprises a plurality of cells which form a hierarchy. The hierarchy is formed by processing a neighbourhood of cells which surround a test cell to determine a target cell of the neighbourhood, which comprises the most entities relative to those associated with the test cell. It is to be appreciated that the test cell may comprise the cell having the most entities compared with its neighbourhood, in which case, the test cell will become the target cell.

The method progressively steps the test cell through each cell of the grid so that each cell of the grid becomes associated with a target cell. The method subsequently groups together test and target cell pairs in the event that the test or target cell of one pair becomes common to another test and target cell pair to form the distribution of cells, namely the hierarchy. In this manner, each cell of the hierarchy comprises a gradual progression for example and increase or decrease in the number of entities to/from a cell maxima of the hierarchy. Accordingly, the cell hierarchies of the space may be considered as discrete steepest-ascent trajectories, since the target cells contain the information regarding the relative difference in numbers of entities, in a particular region of the space. In this embodiment, the method thus groups together cells of the grid, rather that the entities of the network, and thus reduces the subsequent data which is required to be processed in the subsequent processing stage. The method further enables clusters to be formed having an arbitrary shape which is found to further improve the accuracy in the subsequent processing stage.

Similar to the previous embodiment, the size of the neighbourhood within which the test cell is permitted to search, namely the extent to which the neighbourhood extends from the test cell, is found to have a significant influence on the development of the cell distribution and thus the hierarchy. In this respect, a small neighbourhood, is found to generate a large number of maxima and thus hierarchies, whereas a large neighbourhood is found to generate less maxima and thus hierarchies, since in this case, the hierarchies and maxima become assimilated to more populated maxima as the neighbourhood increases. Accordingly, the method of the alternative embodiment further provides for the identification of sub-clusters and thus hierarchical clustering.

In accordance with the present invention as seen from a second aspect, there is provided a conditioning apparatus for conditioning communication network data relating to a distribution of network entities across a space. The apparatus comprises a processor which is arranged to receive network data relating to each entity and process the data according to the method of the first aspect.

### BRIEF DESCRIPTION OF THE DRAWINGS

FIG. 1 is a schematic illustration of a conditioning apparatus according to an embodiment of the present invention operating in a communications network;

FIG. 2 is a flow chart illustrating the steps associated with a first embodiment of the present invention;

FIG. 3 is a graphical representation illustrating the physical distribution of a plurality of network entities;

FIG. 4 is superposition of the network entities illustrated in FIG. 3 upon a two-dimensional grid of cells;

FIG. 5 is a density map which provides a graphical representation of the number of network entities within each cell of the grid;

FIG. 6a-e illustrates a plurality of two-dimensional cell neighbourhoods, which may be used to determine the cell maxima as well as the hierarchy connections, used in the second embodiment.

FIG. 7 is a graphical representation if the cell maxima corresponding to the cells illustrated in FIG. 5;

FIG. 8 is a flow chart illustrating the sequence of steps associated with a second embodiment of the present invention;

FIG. 9a illustrates a portion of the density map illustrated in FIG. 4, with a cell hierarchy produced using a 3×3 cell neighbourhood; and,

FIG. 9b illustrates the portion of the density map illustrated in FIG. 9a, with a cell hierarchy produced using an 11×11 cell neighbourhood.

### DETAILED DESCRIPTION

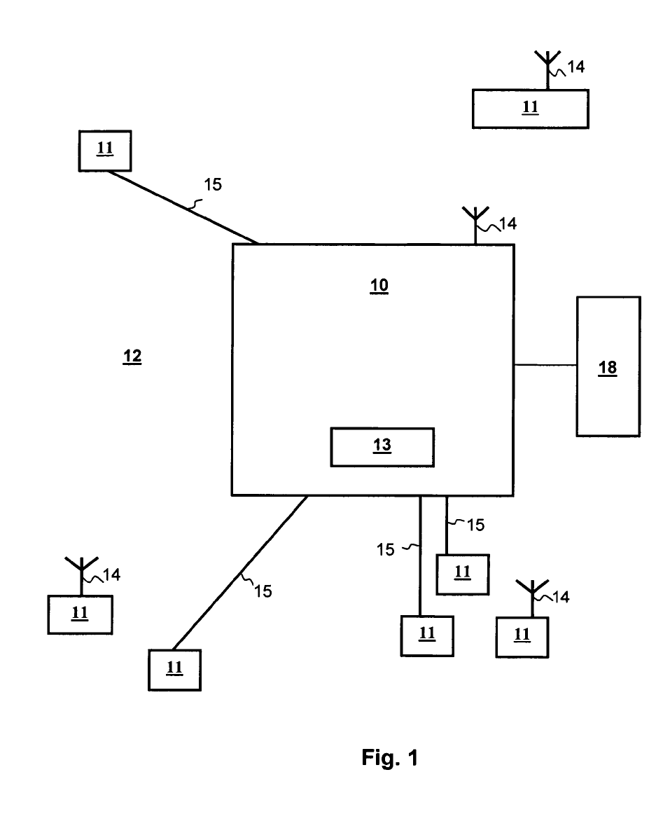

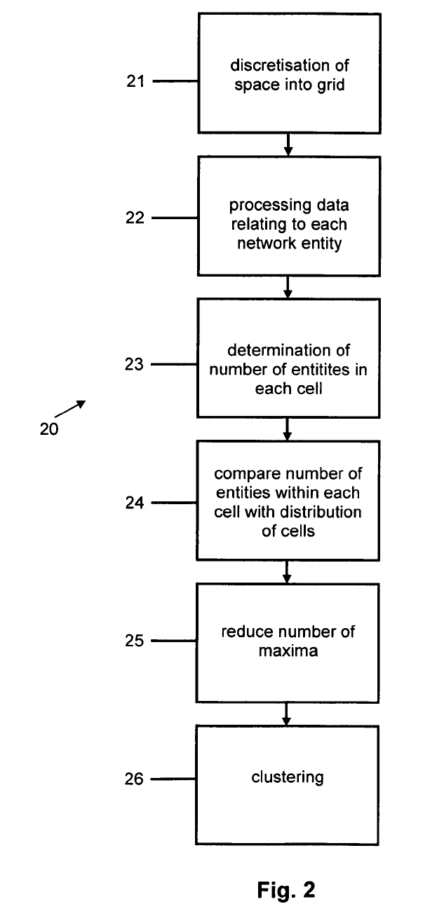

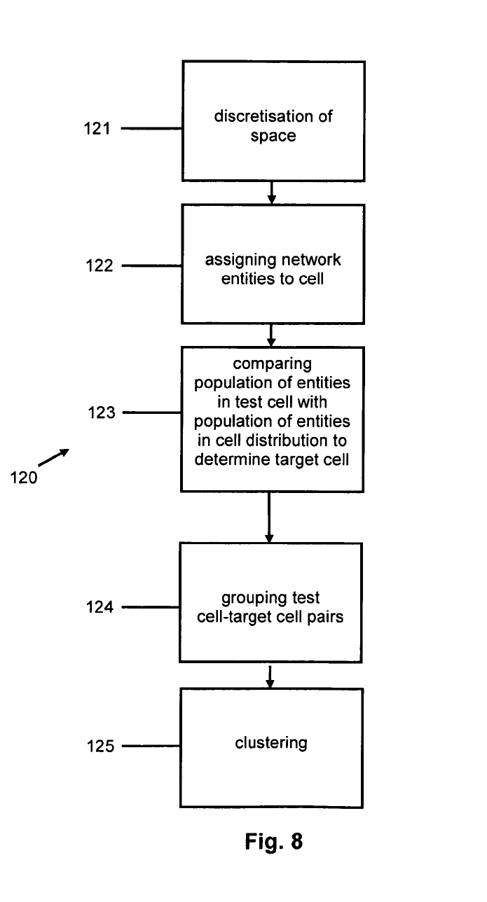

Referring to FIG. 1 of the drawings, there is illustrated a conditioning apparatus 10 according to an embodiment of the present invention for conditioning network data relating to a plurality of network entities 11 distributed about a space 12, such as a geographical space. The conditioning apparatus 10 comprises a processor 13 which is arranged to receive network data from each of the network entities 11 via a wireless connection 14 or a hardwire connection 15, for example, and process the data according to a method 20, 120 according to an embodiment of the present invention as illustrated in FIGS. 2 and 8 of the drawings.

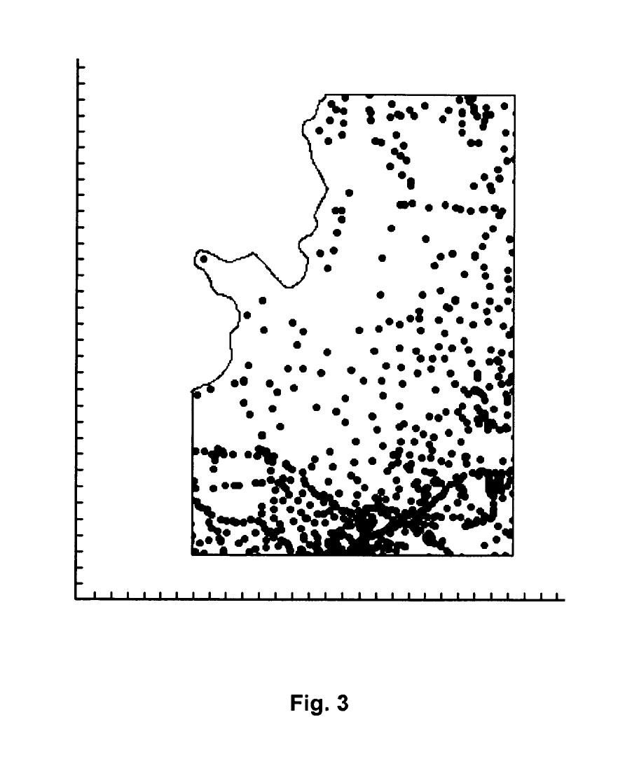

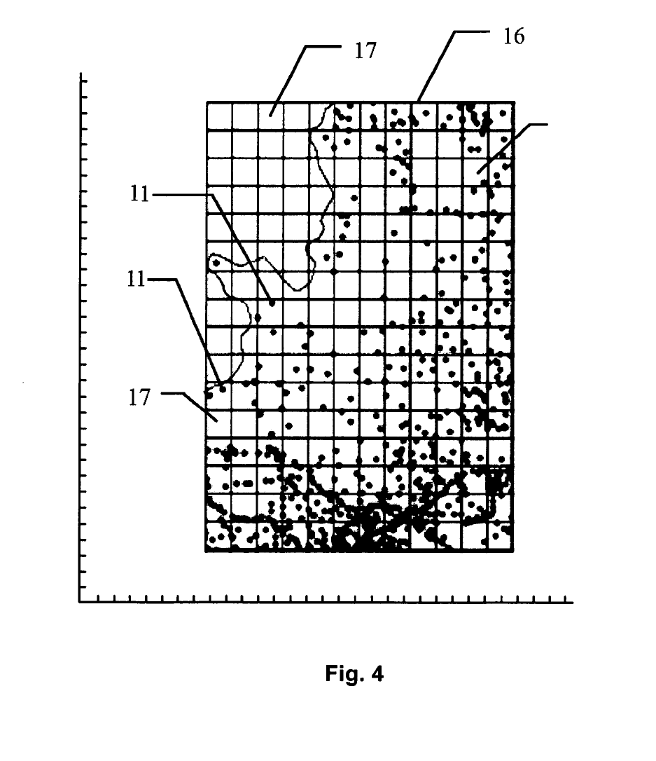

The method 20, 120 of the present invention will be described hereinafter with reference to a two-dimensional distribution of network entities 11 across geographical area, as illustrated in FIG. 3 of the drawings, to provide a visual representation of the underlying principle of the method. However it is to be appreciated that the method 20, 120 may be applied to higher order dimensional systems.

Upon referring to FIG. 3 of the drawings, it is evident that the densest areas of network entities 11 reside in the major cities disposed to the south of the country. However, it is clear that the number of network entities 11 and thus the data sets associated therewith restricts the conveying of information to a user (not shown). Accordingly, in order to provide a more discernable representation and thus provide for an improved processing performance of the data sets, the space 12 occupied by the distribution of entities 11, namely the country, is first discretised at step 21 into a grid 16 comprising a plurality cells 17, each cell 17 occupying a unique location within the grid 16. The resolution of the grid 16, namely the number of cells 17 within the grid 16 is selectable by a user (not shown) to provide for a more refined or a more coarse discretisation of the space 12, depending on the number of entities 11 in the space 12, for example. Empirical rules may be also used for automatically determine the number of cells 17, based on the number of entities 11.

The network data relating to each network entity 11 is subsequently processed using the processor 13 at step 22 and assigned to a particular cell within the grid 16 according to the physical location of the entity 11 within the space 12, relative to the grid 16. In this manner, the longitude (or x-coordinate) and latitude (or y-coordinate) coordinates of each entity 11 is discretised to correspond with a particular cell location (i, j), respectively using the relations:

$$i = ( int ) \frac{( x - {X}_{min} ) * N}{{X}_{max} - {X}_{min}}$$

$$j = ( int ) \frac{( y - {Y}_{min} ) * M}{{Y}_{max} - {Y}_{min}}$$

where N and M represent the number of cells 17 in the x and y directions respectively, and Xmin, Xmax and Ymin, Ymax are the bounds of the area of interest and (int) denotes the conversion to an integer.

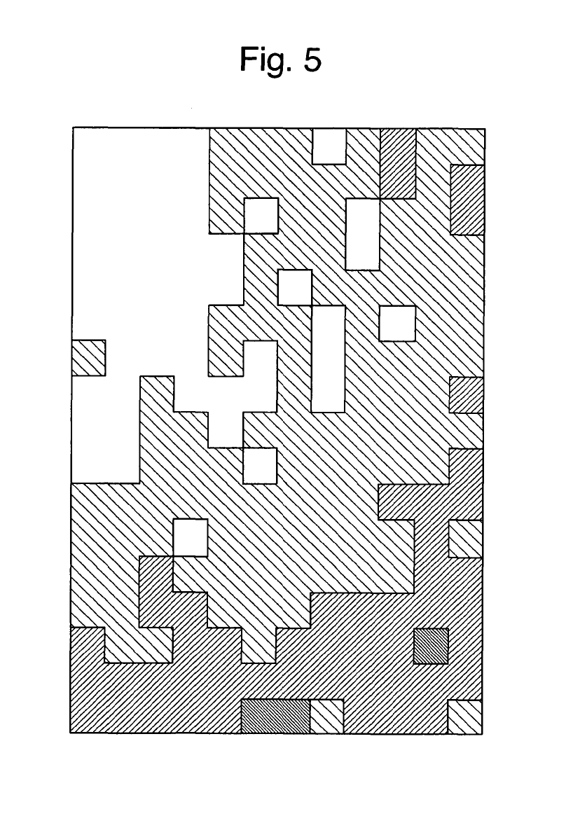

Once all the network entities 11 have been assigned to a particular cell 17, the processor 13 subsequently determines the number of entities within each cell 17 at step 23 and may generate a visual representation of this density distribution of entities 11 across the space 12 using the display unit 18, as illustrated in FIG. 5 of the drawings. The darker cells 17 are arranged to correspond to the higher density areas for example, such as the cities, while the lighter cells 17 are arranged to correspond with low density areas containing little or no network entities 11, for example. The density map is found to provide an intuitive picture of the data set which may be subsequently processed using a clustering algorithm, indicating the major cities as the areas with the highest density.

According to a first embodiment of the method 20 of the present invention, the processor is subsequently arranged to step through each cell 17 of the grid 16 (at step 24 of the method illustrated in FIG. 2 of the drawings) and compare the number of entities 11 within each test cell 17a with a distribution of cells 17, to determine those cells 17 of the grid, termed cell maxima 17b, which comprise more entities than each of the cells 17 of their respective distribution.

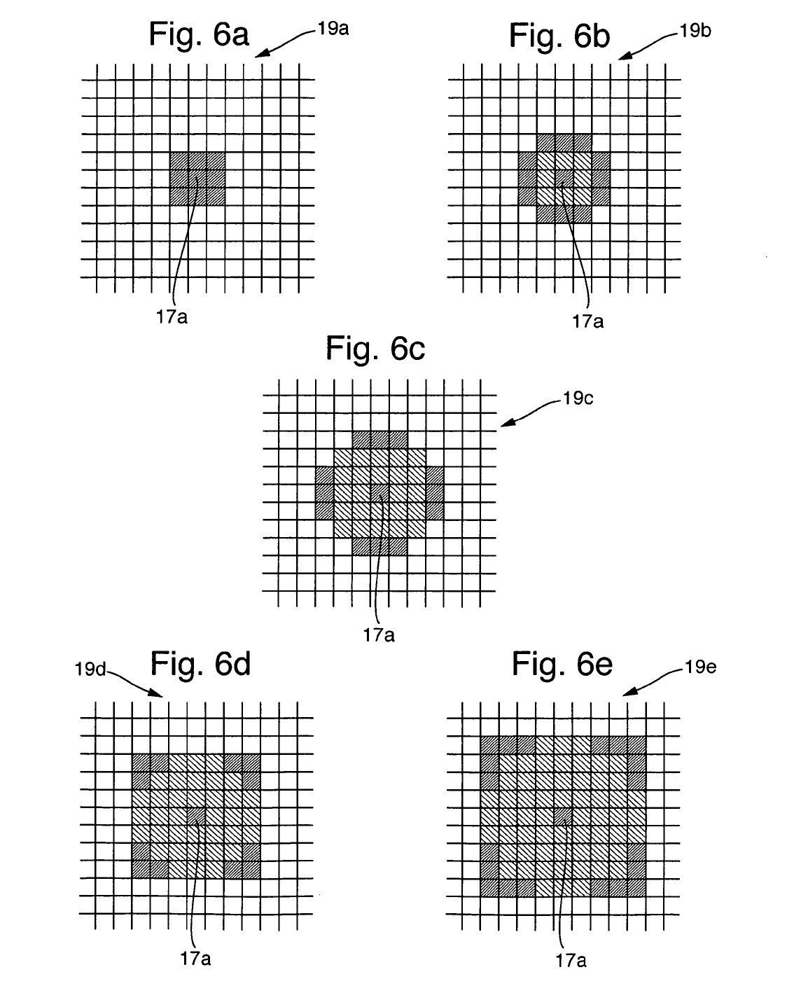

The distribution of cells 17 is defined by a prescribed cell neighbourhood 19 which surrounds the test cell 17a. The types of neighbourhood which may be used in this comparison are illustrated in FIG. 6a-e of the drawings. Referring to FIG. 6, the test cell 17a illustrated as the central shaded cell, is compared to each of the other cells 17 in the defined neighbourhood, which in the neighbourhood 19a illustrated in FIG. 6a, would comprise the 8 cells which directly surround the test cell 17a. In neighbourhood 19d, which is illustrated in FIG. 5d however, the number of entities 11 within the test cell 17d will be compared with the surrounding 48 cells 17. In this respect, the size of the neighbourhood 19a-e will have a direct influence on the number of cell maxima 17b which are identified and thus the proximity of the maxima 17b to each other.

The location and number of cell maxima 17b produced may be directly used as initial cluster locations for a k-means clustering algorithm, for example. The k-means algorithm is an iterative algorithm and at each iteration the location of the cluster centre is adjusted. The Density Map and the Maxima are used only for the initialization of k-means, and not in every iteration. The Maxima are used as “initial approximation” of cluster centres, and in every iteration this approximation is improved. Density Map and Maxima are therefore obsolete during k-means iterations. It is found that when the location of the cell maxima 17b are used, only few iterations are required to achieve the desired convergence, since it is found that the locations of the cell maxima are very close to their final position.

In one embodiment the k-means algorithms is used. However, the k-means algorithm has many variations and in practice, in alternative embodiments, other algorithms using the number and the approximate location of the cluster centres as an input could be used.

Despite the flexibility offered by the selectable resolution and type of neighbourhood 19a-e, it is found that the number of cell maxima 17b returned by the method 20 according to the first embodiment can exceed an expected number of clusters. In which case, the processor 13 is further arranged at step 25 to reduce the number of cell maxima 17b which may be used in the subsequent cluster algorithm at step 26.

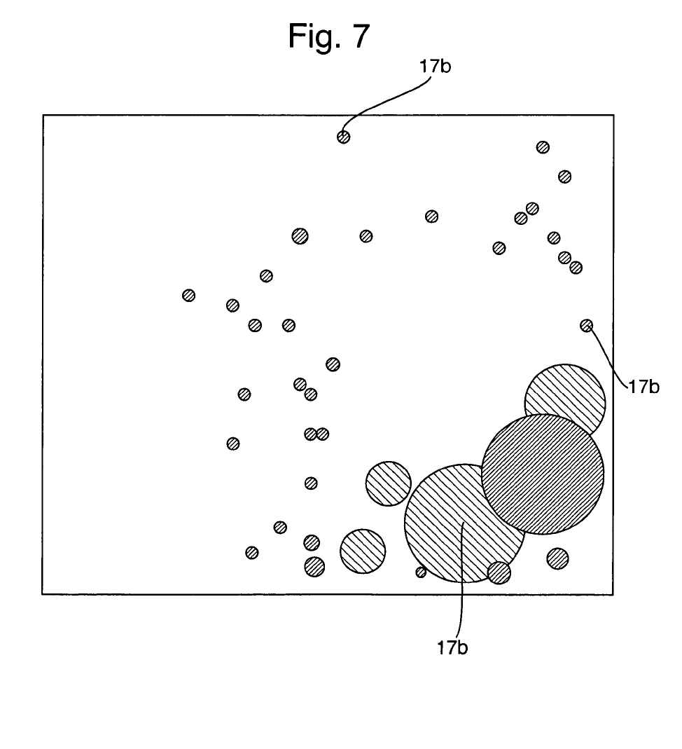

This reduction in the number of cell maxima 17b is achieved by assigning each cell maximum 17b a quality value which may be representative of the population of the entities 11 within the cell maxima 17b, the total population of the cells 17 in the neighbourhood 19 of the cell maxima 17b, the location of the maximum 17b relative to neighbouring maxima 17b, or a combination of the former. FIG. 7 of the drawings provides a graphical illustration of the cell maxima 17b derived from the data illustrated in FIG. 3, using a 50×50 grid resolution and the neighbourhood 19d illustrated in FIG. 5d. The values on the axes in FIG. 7 stand for cell coordinates inside the Density Map. The cell maxima 17b have been represented as circles, with the size of the circles representing the population of entities 11 within the respective cell maxima 17b, with the greyscale being representative of the population of entities 11 within the neighbourhood 19 of the cell maxima 17b, thereby indicating the spread of the data in the area. In this respect, the circles are representative of the quality value of each cell maximum 17b, and may be used to select the location of the cell maxima for subsequent promotion to the cluster algorithm.

Referring to FIG. 8 of the drawings, there is illustrated a method 120 according to a second embodiment of the present invention, for conditioning communication network data relating to a distribution of network entities 11 across a space 12. The method 120 of the second embodiment comprises a number of common steps to the method 20 of the first embodiment and so the steps of the method of the second embodiment have been referenced using the same reference numerals but increased by 100.

Referring to FIG. 8, once the space 12 has been discretised at step 121 and the network entities 11 have been assigned to a particular cell at step 122, the processor 13 of the apparatus 10 is arranged to step through each cell 17 of the grid 16 and compare the population of network entities 11 within the test cell 17a at step 123, with the population of entities 11 within a cell distribution to determine the cell, namely the target cell 17c, of the distribution which comprises the greatest population relative to the test cell 17a.

The cell distribution is similarly defined by a prescribed cell neighbourhood 19a-e which surrounds the test cell 17a, as illustrated in FIG. 6a-e of the drawings. Accordingly, and similar to the method 20 of the first embodiment, the size of the selected neighbourhood 19a-e will have a direct influence on the target cell 17c identified. Each cell 17 of the density map illustrated in FIG. 6, will therefore seek a cell 17 comprising more network entities 11 and if no cell is found comprising more entities 11, then the test cell 17a will comprise the largest number of entities 11 within the neighbourhood 19 and will therefore be promoted to a cell maximum 17b. Otherwise, it will assign the cell found to contain more entries as its target-cell 17c. When viewed from its own perspective, the target-cell 17c itself can be a maximum 17b or not-a-maximum 17a, in which case it will also have a target-cell 17c. Thus, hierarchies of cells are formed, and at the top of each hierarchy resides a maximum 17b.

Once all the associated test-target cells 17a,c have been identified, the processor 13 further groups those test-target cell pairs 17a,c which share a common maximum 17b at step 124, with other test-target cell pairs 17a,c to define a hierarchy of cells 17, with each hierarchy comprising only one cell maximum 17b.

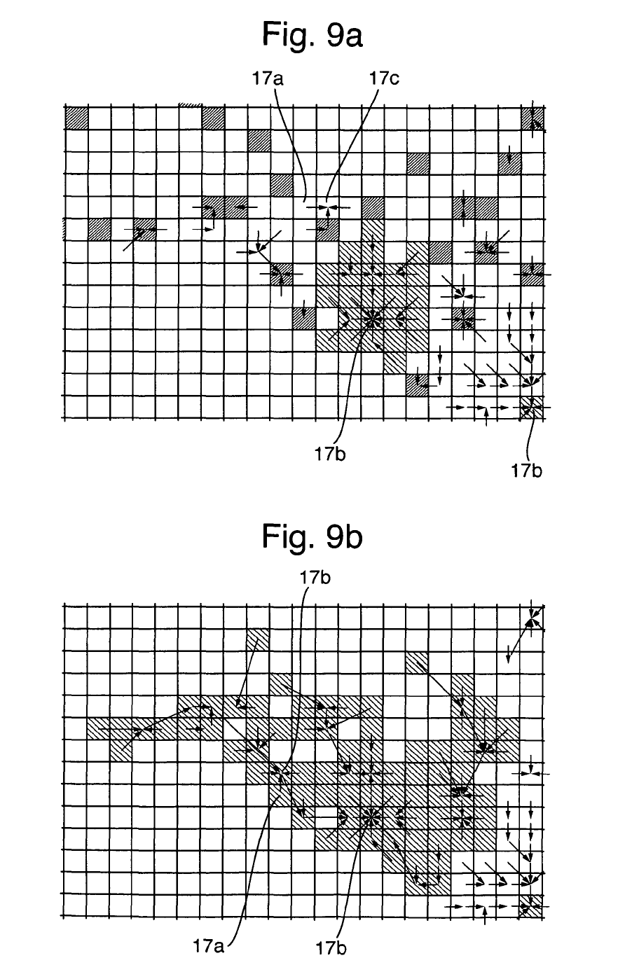

Referring to FIG. 9a of the drawings, there is illustrated a portion of the density map illustrated in FIG. 5. The darker cells denote the cell maxima 17b. The progressive increase in density between cells 17, namely the test-target cell pairs 17a,c has been associated with an arrow, with the arrow head pointing toward the more densely populated (target) cell 17c. The test-target pairs 17a,c have been located using the 3×3 arrangement of cells centred on the test cell 17a, (namely, the neighbourhood 19a illustrated in FIG. 6a) and a cell hierarchy generated using this neighbourhood 19a has been outlined for clarity. For comparison, a cell hierarchy formed using the neighbourhood comprising an 11×11 arrangement of cells centred on the test cell 17a has been illustrated in FIG. 9b of the drawings. The increased range in the neighbourhood enables test-target cell pairs 17a,c to extend over a larger range and so the number of cell maxima 17b generated will be less than for a smaller neighbourhood. In this respect, the cell maxima 17b and hierarchies become progressively assimilated to more populated cell maxima 17b as the size of the searchable neighbourhood 19 increases.

The cell hierarchies of the method 120 of the second embodiment have been described being formed by searching for progressively more populated cells 17 within the grid 16. However, it is to be appreciated that the formation of the cell hierarchies may be equally produced by searching for progressively less populated cells 17 within the grid 16.

Once the location and number of cell maxima 17b have been determined, the location of the cell maxima 17b may be directly used as initial cluster locations for a k-means clustering algorithm, for example at step 125, similar to the method of the first embodiment. The method of the second embodiment offers the advantage over the method of the first embodiment however, that since it is the cells 17 that are grouped, rather that the entities 11 themselves, only N×M cells require processing compared with the actual number of network entities 11. This will therefore significantly reduce the number of processing iterations required by the subsequent cluster algorithm.

While the preferred embodiments of the invention have been shown and described, it will be understood by those skilled in the art that changes or modifications may be made thereto without departing from the true spirit and scope of the invention.

1. A method of conditioning communication network data relating to a distribution of network entities across a space, for subsequent processing of the network data, the method comprising the steps of:
dividing the space into a grid comprising a plurality of discrete cells, each cell comprises a unique location within the space;
processing the network data relating to each entity using a processor to assign the network entity to a cell in dependence of the location of the entity within the space, relative to the cells;
separately determining the number of entities within the cells of the grid;
separately comparing the number of entities within each cell of a respective cell distribution using the processor, to determine the cell maxima of each distribution which comprises the most entities; and,
outputting the location and number of the cell maxima within the grid, to a processor for subsequent processing of the network data, for monitoring of the communication network.

2. The method according to claim 1, wherein the number of cells within the grid is selectable.

3. The method according to claim 1, wherein the space comprises a geographical distribution of network entities.

4. The method according to claim 1, wherein the space and cells are multi-dimensional.

5. The method according to claim 1, in which the cell distribution comprises a neighbourhood of cells which cells surround a test cell.

6. The method according to claim 5, wherein the number of entities within the test cell is compared with the number of entities within each cell of the neighbourhood to determine whether the test cell comprises the cell maxima.

7. The method according to claim 6, wherein the comparison is performed across all cells of the grid to locate the cell maxima.

8. The method according to claim 5, wherein the size of the neighbourhood, determines the location and number of cell maxima generated.

9. The method according to claim 1, further comprising determining the number of cell maxima and assigning each cell maxima a quality value in the event that the number of cell maxima exceeds a threshold.

10. The method according to claim 9, wherein the quality value is representative of the number of entities associated with the respective cell maxima.

11. The method according to claim 5, further comprising determining the number of cell maxima and assigning each cell maxima a quality value in the event that the number of cell maxima exceeds a threshold, wherein the quality value is representative or further representative of the total number of entities associated with the cells of the neighbourhood of the cell maxima.

12. The method according to claim 9, wherein the quality value is representative or further representative of the location of the cell maxima relative to neighbouring cell maxima.

13. The method according to claim 9, further comprising the step of reducing the number of cell maxima in dependence of the quality value.

14. The method according to claim 1, wherein the subsequent processing of the network data comprises the application of a cluster algorithm to the network data relating to the entities of the cell maxima.

15. The method according to claim 14, wherein the cluster algorithm comprises the k-means algorithm.

16. The method according to claim 1, wherein the cell distribution is formed by processing a neighbourhood of cells which surround a test cell to determine a target cell of the neighbourhood, which comprises more entities relative to those associated with the test cell.

17. The method according to claim 16, wherein the test cell is stepped through the cells of the grid to determine a target cell for each test cell.

18. The method according to claim 16, wherein the target cell may comprise the test cell.

19. The method according to claim 16, further comprising grouping test and target cell pairs with other test and target cell pairs in the event that at least one of the test or target cells of one pair is common to the test or target cell of another pair to form a cell hierarchy.

20. The method according to claim 19, wherein the cells of the hierarchy comprise a gradual progression in the number of entities.

21. The method according to claim 19, wherein each cell hierarchy comprises a cell maxima.

22. A method The method according to claim 1, wherein the subsequent processing of the network data comprises the application of a cluster algorithm to the network data relating to the entities of the cell hierarchies.

23. The method according to claim 22, wherein the cluster algorithm comprises a k-means algorithm.

24. A conditioning apparatus for conditioning communication network data relating to a distribution of network entities across a space, the apparatus comprising a processor which is arranged to receive network data relating to each entity and process the data according to the method of claim 1.
